(19) United States
(12) Patent Application Publication
(10) Pub. No.: US 2006/0080296 A1
(43) Pub. Date: Apr. 13, 2006

(54) Text mining server and text mining system

(75) Inventors: Yuji Morikawa, Tokyo (JP); Tadashi Mizunuma, Tokyo (JP); Hajime Tsuneduka, Tokyo (JP); Ayako Fujisaki, Tokyo (JP); Eisuke Kurihara, Kanagawa (JP)

Correspondence Address: Reed Smith LLP;Suite 1400, 3110 Fairview Park Drive, Falls Church, VA, 22042-4503, US

(73) Assignee: Hitachi Software Engineering Co., Ltd.

(21) Appl. No.: 11/189,047

(22) Filed: Jul. 26, 2005

(30) Foreign Application Priority Data
Sep. 29, 2004 (JP) 2004-284291

(51) Int. Cl. G06F 17/30

(52) U.S. Cl. 707/3

(57) ABSTRACT

The characteristics of the entire gene group including a plurality of genes can be readily grasped. A plurality of search keys are accepted from a client, and a set of document groups each corresponding to the plurality of the accepted search keys is obtained, referring to a table where correspondence relationships between the search keys and the document groups are recorded. Then, a characteristic word list having the levels of relative importance is prepared in each of the search keys, and a characteristic table is prepared on the basis of the characteristic word lists. Finally, characteristic table is sorted, colored, and displayed.

### CLAIM OF PRIORITY

The present application claims priority from Japanese application JP 2004-284291 filed on Sep. 29, 2004, the content of which is hereby incorporated by reference into this application.

### BACKGROUND OF THE INVENTION

1. Field of the Invention

The present invention relates to a text mining server and a text mining system for analyzing experimental results in life science fields.

2. Background Art

In the life science fields, much of information is stored as documents in a text-format, and it has become difficult for users to reach information that is really necessary due to large quantities thereof. In recent years, with the improvement of text mining technologies, means for performing text mining on such documents in a text-format to obtain useful information has been widely used. Applications thereof include an analysis of experimental results of microarrays. The analysis of experimental results of microarrays includes grasping the characteristics of as many as tens to hundreds of genes in some form. In order to realize the analysis, one method obtains related document information in each gene and performs text mining on the entire document group that has been obtained. Known genes are registered in a public database and unique IDs are assigned thereto. A search is performed to obtain document information using such KeyID assigned to each gene.

Conventional text mining has method 1 where “the KeyID is transmitted from a client computer to a server computer. The server computer compares the received KeyID with a KeyID/document link table and obtains a document list relating to the KeyID. Then, a characteristic word list is obtained from the text of documents listed in the obtained document list, using a characteristic word extraction program” and method 2 where “genes and characteristic words are held in a longitudinal axis and a lateral axis, and the levels of importance of the characteristic words are calculated as elements to display them in a table”, for example. Documents relating to the text mining include the following Patent Document 1.

Patent Document 1: JP Patent Publication (Kokai) No. 2003-099427 A

### SUMMARY OF THE INVENTION

It is desired in text mining that characteristics that become “dominant” in “many” genes of an inputted gene (KeyID) group be “readily” grasped.

However, in method 1, it is difficult to grasp characteristics that appear in “many” (namely, a plurality of) genes at a time. Also, in method 2, it is difficult to “readily” grasp the characteristics, since the elements of the table are numerals (in other words, further operations are required so as to grasp the characteristics). In some cases of method 2, coloring is performed depending on the level of importance. However, an item indicating the maximum value of the entire table is emphasized, for example, so that it is impossible to determine whether the item indicates the characteristics that are “dominant” in common with “many” genes (in other words, the problem is that values are evaluated not by a relative scale in each KeyID, but by an absolute scale unified in the entire table).

It is an object of the present invention to provide means for readily grasping characteristics that become dominant in common with many genes of an inputted gene group.

In order to achieve the aforementioned object, a text mining server of the present invention comprises search key accepting means for accepting a plurality of search keys and means for searching a database in which corresponding relationships between the search keys and document groups are recorded and for obtaining a set of document groups each corresponding to the plurality of the accepted search keys. The text mining server further comprises characteristic word list preparation means for extracting characteristic words from the obtained document groups and for calculating the level of relative importance in each of the plurality of the accepted search keys, thereby preparing a characteristic word list, characteristic table preparation means for preparing a characteristic table by collecting the characteristic word lists of each of the search keys, and output means for outputting the characteristic table as mining results. Further, a client computer comprises characteristic table reception means for receiving the characteristic table prepared in the text mining server and means for sorting and coloring the received characteristic table and for displaying the table.

The functions of the text mining server and the client computer are realized by a computer program.

According to the present invention, the characteristics of each gene are displayed using the levels of relative importance, so that important characteristic words in each gene can be grasped. Consequently, characteristics that become dominant in common with many genes can be grasped. Moreover, by performing sorting and coloring, the characteristics that become dominant in common with many genes can be visually captured.

### BRIEF DESCRIPTION OF THE DRAWINGS

FIG. 1 shows a conceptual diagram of a text mining system according to the present invention.

FIG. 2 shows an example of a KeyID/document link table.

FIG. 3 shows an example of document information.

FIG. 4 shows an example of a screen of a KeyID transmission program.

FIG. 5 shows an example of a flow chart of a characteristic word list preparation program.

FIG. 6 shows an example of a characteristic word list.

FIG. 7 shows an example of a flow chart of a characteristic table preparation program.

FIG. 8 shows an example of a characteristic table.

FIG. 9 shows an example of a sorted characteristic table.

FIG. 10 shows an example of a colored characteristic table.

FIG. 11 shows an example of a flow chart of text mining according to the present invention.

### DESCRIPTION OF THE PREFERRED EMBODIMENTS

In the following, an embodiment of the present invention is concretely described with reference to the drawings.

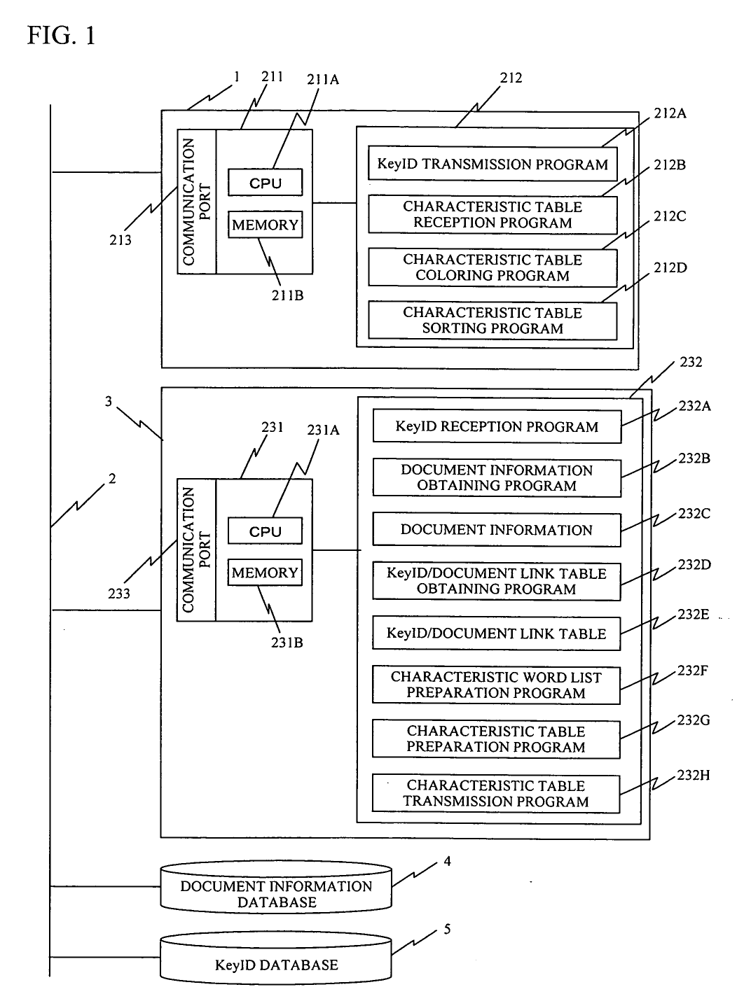

FIG. 1 shows a conceptual diagram of a text mining system according to the present invention. The system shown in this case comprises a client computer 1 (hereafter simply referred to as a client) for inputting and transmitting a KeyID and receiving and coloring a characteristic table, a text mining server computer 3 (hereafter simply referred to as a server) for performing text mining, a document information database 4 for holding document information, and a KeyID database 5 for holding a relation table (or information to be used as a basis of preparation thereof) of a KeyID and document information. Each element is connected via a network 2.

The client 1 comprises a terminal device 211 provided with a CPU 211A and a memory 211B, a hard disk device 212 where a KeyID transmission program 212A, a characteristic table reception program 212B, a characteristic table coloring program 212C, and a characteristic table sorting program 212D are stored, and a communication port 213 for connecting to a network. The server 3 comprises a terminal device 231 provided with a CPU 231A and a memory 231B, a hard disk device 232 to store a KeyID reception program 232A for receiving a KeyID transmitted from the client 1, a document information obtaining program 232B for obtaining the following document information 232C from the document information database 4, a KeyID/document link table obtaining program 232D for obtaining the following KeyID/document link table 232E from the KeyID database 5, a characteristic word list preparation program 232F for extracting characteristic words from the document information 232C, a characteristic table preparation program 232G for preparing a characteristic table where the characteristics of KeyID groups are collected, and a characteristic table transmission program 232H for transmitting the characteristic table as mining results, and a communication port 233 for connecting to the network.

The document information 232C is information of a necessary portion taken from the document information database 4, and it is held in the hard disk device 232 of the server. The KeyID/document link table 232E is prepared from the KeyID database 5 for holding the relation table (or information to be used as a basis of preparation thereof) of the KeyID and document information, and the KeyID/document link table 232E is held in the hard disk device 232 of the server. In practice, information used for text mining is held locally in this manner from the databases connected to the network.

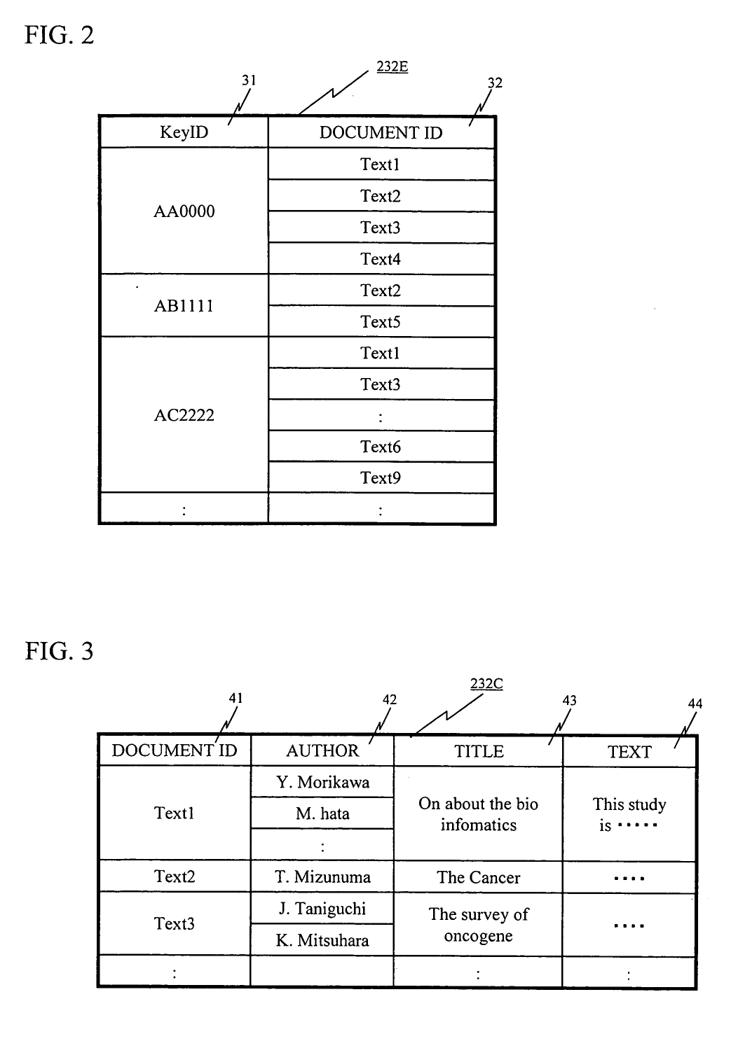

FIG. 2 shows an example of the KeyID/document link table 232E stored in the hard disk device 232 of the server 3. Groups of KeyIDs 31 and document IDs 32 relating to each KeyID are stored. In the table, for example, regarding a gene having a KeyID of “AA0000”, four documents, namely, “Text 1”, “Text 2”, “Text 3”, and “Text 4” are registered as documents relating thereto. Regarding a gene having a KeyID of “AB1111”, two documents, namely, “Text2” and “Text5” are registered as documents relating thereto.

FIG. 3 shows an example of the document information 232C stored in the hard disk device 232 of the server 3. In the document information 232C, groups of document IDs 41, authors 42 of each document ID, titles 43, and text 44 are stored. The document IDs 41 correspond to the document IDs 32 of FIG. 2. In this example, although the authors, titles, and text are stored as document information, other information such as abstracts and published years, for example, may be stored as document information.

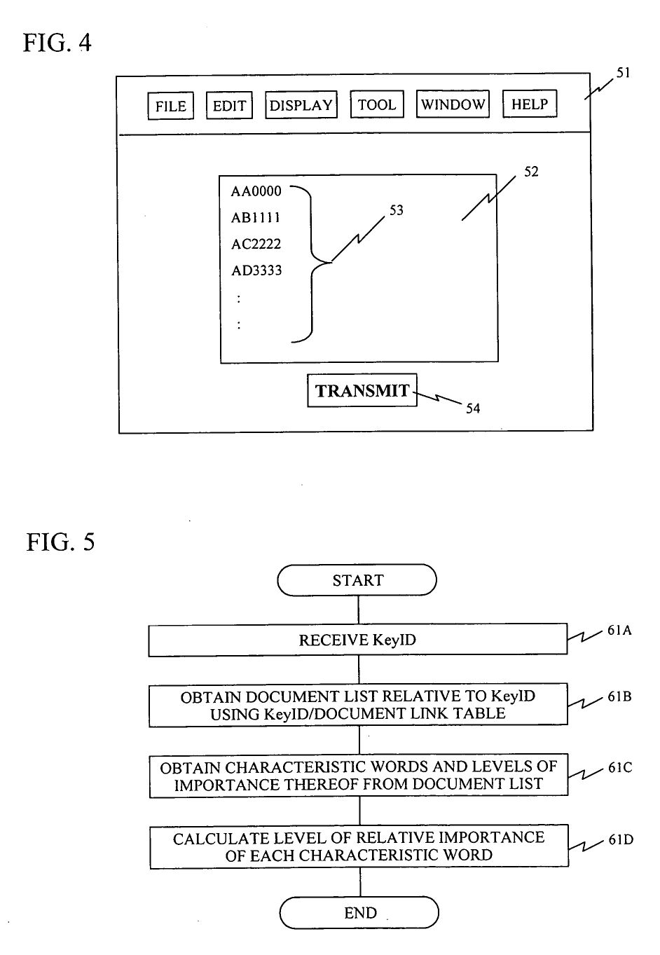

FIG. 4 shows an example of a screen of the KeyID transmission program 212A operating on the client 1. A menu 51, a KeyID input field 52, and a transmission button 54 are disposed on the screen. When KeyIDs are inputted into the KeyID input field 52 (they are inputted as shown by numeral 53, for example. A plurality of KeyIDs may be inputted), by pressing down the transmission button 54, the inputted KeyIDs 53 are transmitted to the text mining server 3.

FIG. 5 shows an example of a flow chart of the characteristic word list preparation program 232F operating on the server 3. The preparation of a characteristic word list is initiated by receiving one of the KeyIDs received via the KeyID reception program 232A (step 61A), and then related documents are obtained (step 61B) by comparing the KeyID with the KeyID/document link table 232E (FIG. 2). Next, characteristic words are extracted from the related documents that have been obtained and the levels of importance thereof are calculated (step 61C). Although the calculation method of the levels of importance is arbitrary, examples include a method that employs tf (Term Frequency) and idf (Inverse Document Frequency) widely used in the field of text mining. The tf and idf is a method in which when T(W) represents the total number of documents that include a word W, N represents the total number of documents, and F(W, Q) represents the frequency of appearance of the word W in a document Q, the level of importance of the word W in the document Q is defined by “F(W, Q)*Log[N/T(W)]”. F(W, Q) corresponds to the tf, and Log[N/T(W)] corresponds to the idf. Regarding the characteristic words to be extracted, ten characteristic words are extracted in descending order of the levels of importance, for example. Next, the level of relative importance of each characteristic word is calculated (step 61D).

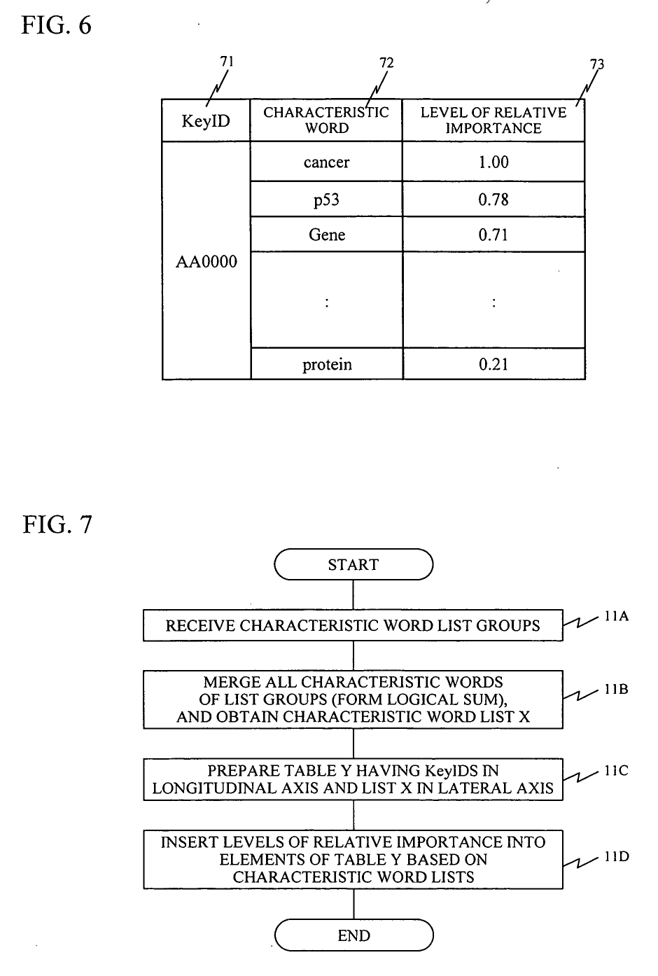

FIG. 6 shows an example of the characteristic word list prepared via the characteristic word list preparation program 232F. In this list, a KeyID 71, characteristic words 72 of the KeyID, and the levels of relative importance 73 of the characteristic words are stored. In this case, the level of relative importance is a value obtained by dividing the level of importance (tf and idf values, for example) calculated in each word by the maximum level of importance. Thus, each characteristic word list always contains a word indicating one in the level of relative importance, and the values of the levels of relative importance are not more than one. The characteristic word list is finally sent to the characteristic table preparation program 232G.

FIG. 7 shows an example of a flow chart of the characteristic table preparation program 232G operating on the server 3. The characteristic table preparation program 232G prepares a characteristic table from the characteristic word lists prepared as many as the number of the KeyIDs that has been received via the KeyID reception program 232A. The procedure of the preparation starts by receiving a characteristic word list group prepared via the characteristic word list preparation program 232F (step 11A). Next, a list X in which the characteristic words of each KeyID are merged is obtained (step 11B) and a table Y having the KeyIDs and the list X in a longitudinal axis and a lateral axis respectively, is prepared (step 11C). Then, the levels of relative importance are inserted as the elements of the prepared table Y on the basis of each characteristic word list (step 11D).

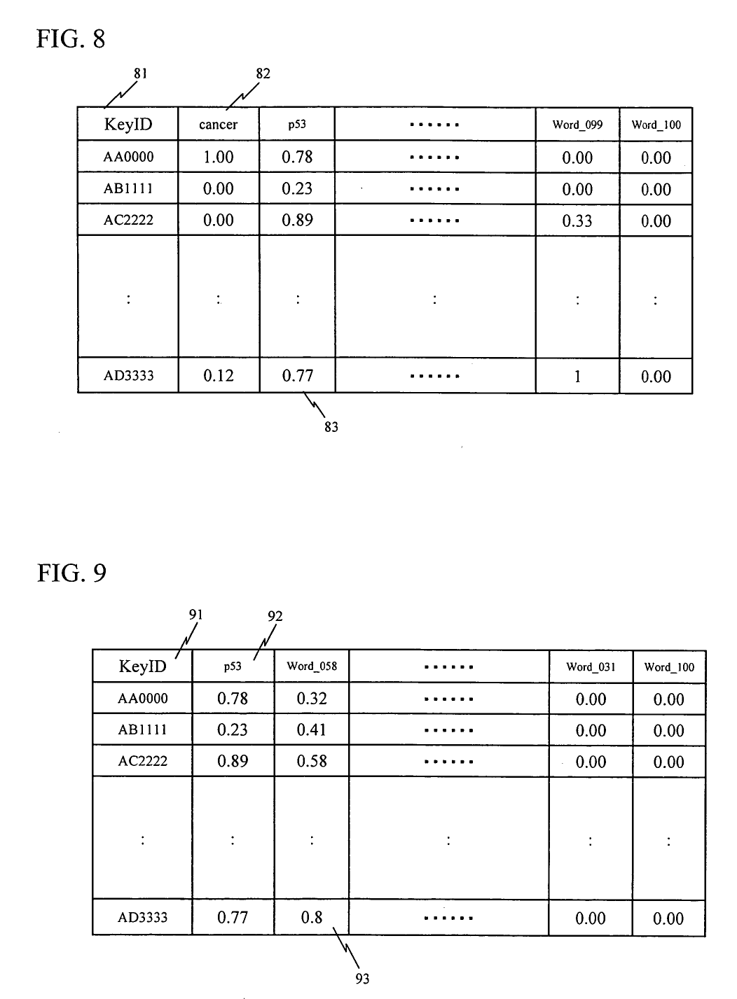

FIG. 8 shows an example of the characteristic table prepared via the characteristic table preparation program 232G. The characteristic table has KeyIDs 81 that are received via the KeyID reception program 232A in a longitudinal axis, characteristic words 82 in a lateral axis, and the levels of relative importance 83 as elements. The KeyIDs 81 correspond to numeral 71 of FIG. 6, the characteristic words 82 correspond to numeral 72 of FIG. 6, and the levels of relative importance 83 correspond to numeral 73 of FIG. 6.

FIG. 9 shows an example of the characteristic table sorted via the characteristic table sorting program 212D. The characteristic table has KeyIDs 91 in a longitudinal axis, characteristic words 92 in a lateral axis, and the levels of relative importance 93 as elements. The objects of sorting are the columns of the characteristic table received via the characteristic table reception program 212B and the sorting is performed on the basis of the following, for example.

(i) The sum of the levels of relative importance is calculated in each column and the columns are arranged from the left of the table in descending order of summed values.

(ii) If the summed values are the same in (i) above, the numbers of the KeyIDs having the level of relative importance greater than zero in each column are compared and a column having a larger number is disposed on the left of the table.

(iii) If the numbers of the KeyIDs are the same in (ii) above, the maximum values in each column are compared and a column having a higher value is disposed on the left of the table.

(iv) If all the conditions of (i) to (iii) above are the same, sorting is performed in alphabetical order, for example.

In accordance with this procedure, word groups indicating dominant characteristic relative to the inputted KeyIDs are collected on the left of the characteristic table, thereby readily enabling the grasping of the characteristics.

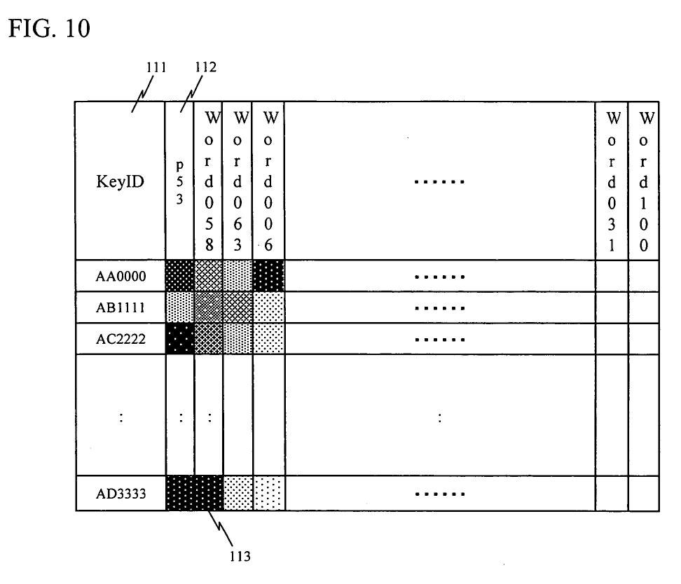

FIG. 10 shows an example of the characteristic table colored via the characteristic table coloring program 212C. The characteristic table has KeyIDs 111 in a longitudinal axis, characteristic words 112 in a lateral axis, and colored cells 113 as elements. FIG. 10 corresponds to FIG. 9 and the cells 113 are colored on the basis of the levels of relative importance 93 of FIG. 9. Although a coloring method is arbitrary, a method employing a heat map used for expression analysis of microarrays can be considered, for example. With this coloring, the differences of the intensity of the characteristics can be visually grasped in each column of the characteristic table, and it becomes possible to readily grasp a KeyID that intensely indicates the characteristics in one column.

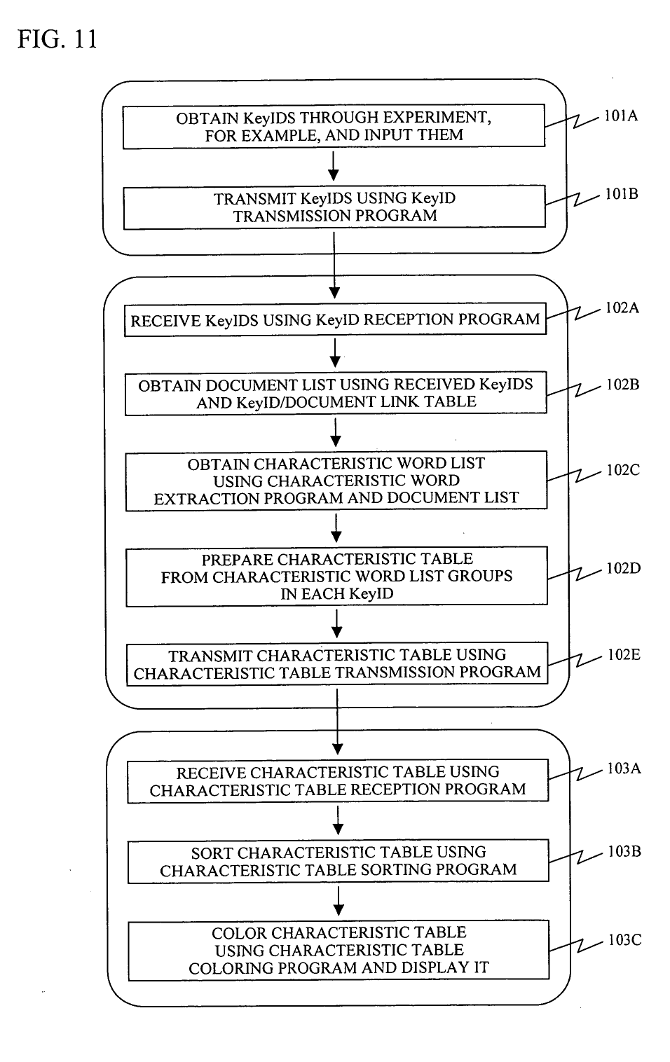

FIG. 11 shows an example of a flow chart regarding a procedure from inputting the KeyIDs to obtaining the colored characteristic table, using the present system. The preparation of a characteristic table is initiated by inputting a plurality of KeyIDs in the client 1 (step 101A), and then the plurality of the inputted KeyIDs are transmitted to the server 3 (step 101B). The server 3 receives the transmitted KeyIDs (step 102A) and obtains related documents in each KeyID (step 102B) by comparing the received KeyIDs with the KeyID/document link table 232E (FIG. 2). In step 102C that follows, the characteristic word list preparation program 232F is executed on the related documents of each KeyID and a characteristic word list (FIG. 6) is prepared in each KeyID. Further, a characteristic table is prepared (step 102D) from a prepared characteristic word list group using the characteristic table preparation program 232G, and then transmitted to the client 1 via the characteristic table transmission program 232H (step 102E). The client 1 receives the transmitted characteristic table (step 103A), performs sorting using the characteristic table sorting program 212D (step 103B), and performs coloring using the characteristic table coloring program 212C and displays it (step 103C), thereby ending the flow of the procedure.

1. A text mining server comprising:
search key accepting means for accepting a plurality of search keys;
means for searching a database, wherein corresponding relationships between the search keys and document groups are recorded, and for obtaining a set of document groups each corresponding to the plurality of the accepted search keys;
characteristic word list preparation means for extracting characteristic words and levels of relative importance of the characteristic words from the set of the document groups corresponding to the search keys and for preparing a characteristic word list in each of the accepted search keys;
characteristic table preparation means for preparing a characteristic table, wherein the characteristic words are merged from the characteristic word lists prepared as many as the number of the search keys; and
output means for outputting the characteristic table as mining results.

2. The text mining server according to claim 1, wherein the search key accepting means receives a plurality of search keys from a client computer and the output means transmits the mining results to the client computer.

3. The text mining server according to claim 1, wherein the search key comprises an identifying symbol for specifying a gene.

4. A program for enabling a computer to operate as the text mining server comprising search key accepting means for accepting a plurality of search keys; means for searching a database, wherein corresponding relationships between the search keys and document groups are recorded, and for obtaining a set of document groups each corresponding to the plurality of the accepted search keys; characteristic word list preparation means for extracting characteristic words and levels of relative importance of the characteristic words from the set of the document groups corresponding to the search keys and for preparing a characteristic word list in each of the accepted search keys: characteristic table preparation means for preparing a characteristic table, wherein the characteristic words are merged from the characteristic word lists prepared as many as the number of the search keys; and output means for outputting the characteristic table as mining results.

5. A text mining system including the text mining server which comprises search key accepting means for accepting a plurality of search keys; means for searching a database, wherein corresponding relationships between the search keys and document groups are recorded, and for obtaining a set of document groups each corresponding to the plurality of the accepted search keys; characteristic word list preparation means for extracting characteristic words and levels of relative importance of the characteristic words from the set of the document groups corresponding to the search keys and for preparing a characteristic word list in each of the accepted search keys; characteristic table preparation means for preparing a characteristic table, wherein the characteristic words are merged from the characteristic word lists prepared as many as the number of the search keys; and output means for outputting the characteristic table as mining results; and the client computer, wherein the search key accepting means receives a plurality of search keys from a client computer and the output means transmits the mining results to the client computer; and wherein
the client computer comprises:
search key transmission means for transmitting a plurality of search keys to the text mining server;
characteristic table reception means for receiving the characteristic table from the text mining server;
characteristic table sorting means for sorting the received characteristic table; and
characteristic table coloring means for coloring the sorted characteristic table.

6. The text mining system according to claim 5, wherein the search key comprises an identifying symbol for specifying a gene.
